(19) United States
(12) Patent Application Publication
(10) Pub. No.: US 2014/0082495 A1
(43) Pub. Date: Mar. 20, 2014

(54) MEDIA SYSTEMS AND PROCESSES FOR PROVIDING OR ACCESSING MULTIPLE LIVE PERFORMANCES SIMULTANEOUSLY

(71) Applicant: VS Media, Inc., Calabasas, CA (US)

(72) Inventors: Bradley Jay Estes, Woodland Hills, CA (US); Scott Matthew Lawson, Westlake Village, CA (US); Craig Gavin Miller, Simi Valley, CA (US); Douglas Lawrence Gatza, Camarillo, CA (US)

(73) Assignee: VS Media, Inc., Calabasas, CA (US)

(21) Appl. No.: 13/948,014

(22) Filed: Jul. 22, 2013

Related U.S. Application Data
(60) Provisional application No. 61/702,654, filed on Sep. 18, 2012.

(51) Int. Cl. G06F 3/0482

(52) U.S. Cl. CPC G06F 3/0482
USPC 715/716

(57) ABSTRACT

A system provides to second users on a communication network, electronic media content for at least one ongoing, live performance being performed for a first user. The system provides the second user with a menu having a plurality of selectable menu items, each corresponding to an ongoing live media performance. The system receives selection information from the second user, corresponding to one or more of the menu items. The system provides the second user with displayable content for displaying, through a single browser frame, one or more of the ongoing live media performance to which the selected one or more of the menu items corresponds.

### CROSS-REFERENCE TO RELATED PATENT APPLICATIONS

This application claims priority from Provisional U.S. Application 61/702,654 filed Sep. 18, 2012, incorporated herein by reference in its entirety.

### BACKGROUND

The present invention relates to media systems and processes and, in particular embodiments, to systems and processes for providing or accessing multiple live performances simultaneously over an electronic communication network.

### SUMMARY OF THE DISCLOSURE

Embodiments of the present invention relate to systems and processes for providing media performances to users on computer networks. Particular embodiments relate to service systems and processes for providing media content streams (or other forms of media content) of multiple live media performances or shows, while the live performances or shows are being performed.

One or more network sites (such as Internet websites or website pages) are accessible by users, for accessing a service that provides displayable content in the form of live performances or shows. According to embodiments of the present invention, a plurality of users access the service through user devices, where some users employ an interactive performance mode of the service and other users employ a passive viewing mode of the service.

In the interactive performance mode, the user obtains an interactively directed live performance or show, in which the user may provide control information to control or direct aspects of the performance or show, or provide demands or recommendations for the performer to perform as part of the performance or show. In the passive viewing mode, the user may select and view one or more ongoing interactive performances or shows simultaneously, but without the ability to provide control information, through a single interface (such as, but not limited to, a single browser frame).

### BRIEF DESCRIPTION OF THE DRAWINGS

FIG. 1 is a generalized diagram of a network on which a system according to an embodiment of the present disclosure operates.

FIG. 2 is a generalized diagram showing a system, according to an embodiment of the present disclosure.

FIG. 3 is a diagram of a display screen showing a menu for an interactive performance mode or service, according to an embodiment of the present disclosure.

FIG. 4 is a diagram of a display screen showing a menu for a passive viewing mode or service, according to an embodiment of the present disclosure.

FIG. 5 is a diagram of a further display screen for a passive viewing mode or service, according to an embodiment of the present disclosure.

FIG. 6 is a diagram of yet a further display screen for a passive viewing mode or service, according to an embodiment of the present disclosure.

FIG. 7 is a diagram of yet a further display screen for a passive viewing mode or service, according to an embodiment of the present disclosure.

### DETAILED DESCRIPTION OF THE EMBODIMENTS

In the following description of preferred embodiments, reference is made to the accompanying drawings which form a part hereof and in which are shown by way of illustration specific embodiments in which the invention may be practiced. It is to be understood that other embodiments may be utilized and structural changes may be made without departing from the scope of the preferred embodiments of the present disclosure.

Embodiments of the present invention relate to systems and processes for providing media performances to users on computer networks and, in particular embodiments, to service systems and processes for providing media content streams (or other forms of media content) of multiple live media performances or shows, while the live performances or shows are being performed, for displaying multiple live media performances or shows simultaneously on a user's network-connected device. Embodiments of the present invention also allow the user to select live performances or shows to be displayed from among a menu of ongoing live performances or shows. Further embodiments of the present invention relate to systems and processes for users to access such live media performances or shows.

Such live media performances or shows are electronically captured at performers' locations and communicated to users in the form of live video streams, live audio streams, live tactile signal streams, other forms of live video, live audio or live tactile signals, combinations thereof or the like. A live media performance or show, in the context of embodiments of the present invention, refers to a media performance that is being carried out (or performed) by a performer and inputted through a media capture device at the same time that the performance is being communicated to a user. In particular embodiments, a live performance or show may include some delays between capture and delivery of performance content, where such delays are associated with technical aspects of capturing and communicating the content. However, such delays are typically far less than the overall period of the performance, such that at least a portion of the performance content is delivered to the user while the live performance or show is being carried out.

Embodiments of the present invention employ one or more network sites (such as Internet websites or website pages) accessible by users on user devices, for accessing a service that provides displayable content in the form of live performances or shows. According to embodiments of the present invention, a plurality of users access the service through user devices, where some users employ an interactive performance mode of the service and other users employ a passive viewing mode of the service. In the interactive performance mode, the user obtains an interactively directed live performance or show, in which the user may provide control information to control or direct aspects of the performance or show, or provide demands or recommendations for the performer to perform as part of the performance or show. In the passive viewing mode, the user may select and view one or more ongoing interactive performances or shows simultaneously, but without the ability to provide control information. In the passive viewing mode, the user views one or more ongoing interactive performances or shows through a single interface (such as, but not limited to, a single browser frame).

### Hardware System Environment

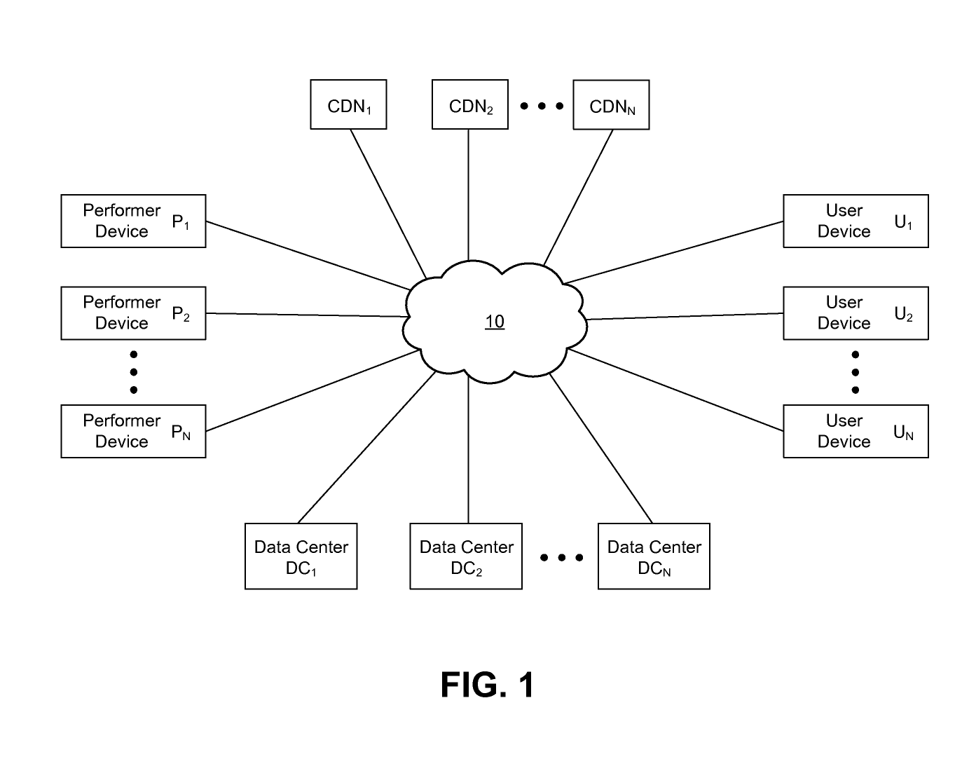

A system according to an embodiment of the present invention operates with one or more electronic communication networks, such as, but not limited to, wide area networks including the Internet, Intranets, local area networks, combinations thereof, or the like. In the example shown in FIG. 1, a communication network 10 (such as the Internet) provides a communication link between a plurality of communication devices connected to the network. The communication devices or computers are programmed or otherwise configured to provide communication and other operations described herein.

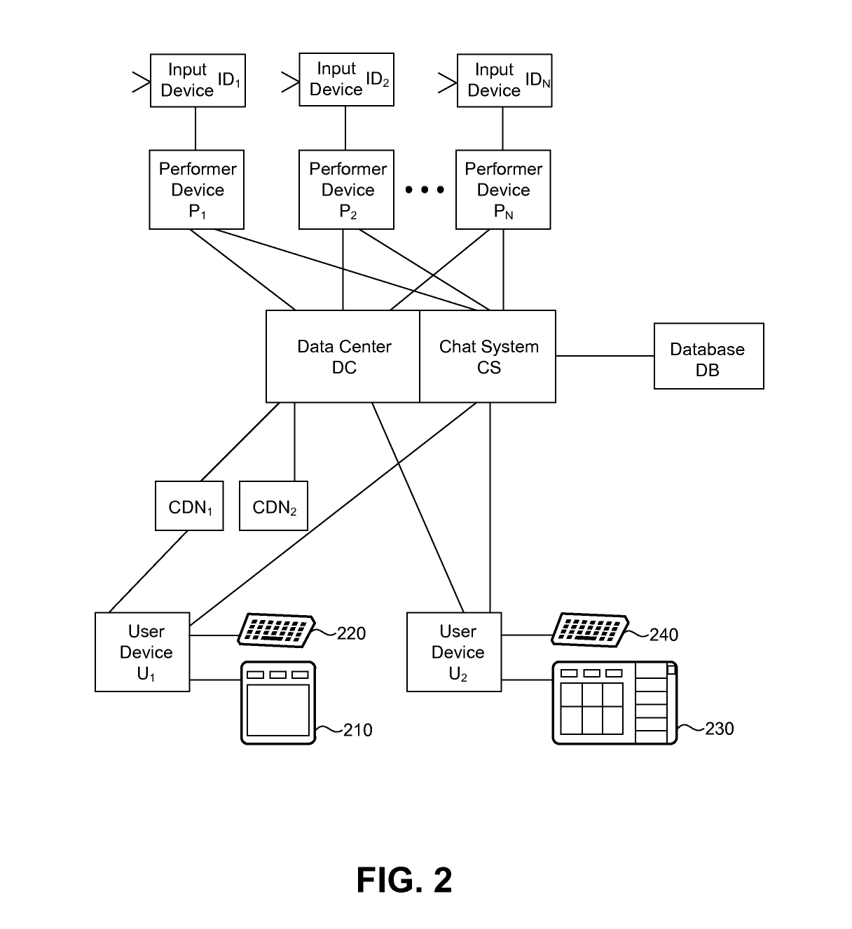

In the embodiment of FIG. 1, the communication devices include User Devices (U_{1-N}), Performer Devices (P_{1-N}) and Data Center devices (DC_{1-N}), each coupled for communication over the network 10. Particular embodiments also include one or more Content Delivery Network Provider devices (CDN_{1-N}) coupled for communication over the network 10. A system according to embodiments of the present invention, is configured to provide one or more users, each operating an associated one of the User Devices (U_{1-N}), with performance content for live performances of a plurality of performers, each operating a respective, associated Performer Device (P_{1-N}). FIG. 2 shows a data flow diagram, simplified to show a single Data Center device (DC).

The Data Center devices (DC_{1-N}) are operated by one or more service provider entities that provide one or more services or parts of services described herein, and may include one or more companies, corporations, government agencies, educational entities, individuals or other entities. Each Data Center device (DC_{1-N}) operates to provide one or more complete service or a part of one or more service relating to providing users with performance content for live performances or shows, as described herein. In particular embodiments, each Data Center device (DC_{1-N}) operates with one or more Content Delivery Network Provider that use computer server systems (CDN_{1-N}) for serving or delivering content provided by the Data Center device (or from Performer Devices (P_{1-N}) through a CDN server) to one or more User Devices (U_{1-N}). In further embodiments, one or more of the Data Center devices (DC_{1-N}) operates to serve or deliver content directly to one or more of the User Devices (U_{1-N}), without going through a separate CDN server, as shown in one of the data flow connections between the Data Center (DC) and a second user's User Device U₂ in FIG. 2.

In FIGS. 1 and 2, the plurality of Performer Devices are represented as P₁, P₂ . . . P_{N} (where N represents an integer greater than 2). Each Performer Device (P_{1-N}) includes a communication device associated with at least one performer. The communication device may include any suitable network-connectable device capable of operating in the manner described herein, such as, but not limited to one or more, desk top computers, laptop computers, mainframe computers, IPAD™ or other electronic pad devices, phones with data processors, personal digital assistants, or the like. Each Performer Device (P_{1-N}) includes or operates with a media capturing device (e.g., media Input Devices ID_{1-N} in FIG. 2), such as, but not limited to, a camera, a microphone, a tactile input device, combinations thereof, or the like, capable of electronically capturing one or more user-perceptible aspect of a live performance or show, such as, but not limited to, a video, audio and/or tactile aspect of the live performance or show. In particular embodiments, each Performer Device (P_{1-N}) also includes one or more input devices for inputting textual information, such as, but not limited to a keyboard, touch-screen, electronic writing pad or pen, or the like.

In addition, each Performer Device (P_{1-N}) includes suitable hardware, software, firmware, combinations thereof, or the like, for connecting to the network 10 and communicating content captured by the media capturing device, over the network 10. In particular embodiments, such software, firmware, hardware, or the like, includes one or more software application, firmware or hardware configurations for interfacing with one or more of the Data Centers (DC_{1-N}) and User Devices (U_{1-N}) in a manner as described herein. Such software is stored on one or more electronic storage devices included or associated with each Performer Device (P_{1-N}) such as, but not limited to, a hard drive, read only memory ROM device, random access memory RAM device, or other non-transient electronic storage device.

In particular embodiments, each Performer Device (P_{1-N}) also includes or operates with a suitable electronic display device for displaying information received over the network 10 to the performer associated with the associated Performer Device. The electronic display devices associated with the Performer Devices (P_{1-N}) may include one or more of an electronic display screen for displaying video or still image content, a speaker or other audio producing device for displaying (playing) audible content, a tactile output device for displaying (providing) tactile content, combinations thereof, or the like.

In the embodiment in FIGS. 1 and 2, more then two Performer Devices (P_{1-N}) are shown. In other embodiments, any suitable number of (including one, two or more) Performer Devices may be employed. In an example embodiment, each Performer Device (P_{1-N}) in FIG. 1 is associated, on a one-to-one basis, with a respective performer. In other embodiments, multiple performers may be associated with one Performer Device and/or one or more performers may each be associated with multiple Performer Devices. In particular embodiments, a performer is a person (or people) who provides a live performance that can be electronically captured and transmitted over the communication network 10 in any suitable form, such as, but not limited to, video, audio, or tactile signals, combinations thereof or the like. Such performances may include, but are not limited to, sports performances, educational lectures, electronic game play performances, plays or acts, burlesque shows, psychic readings, seances, interviews, or the like.

In FIG. 1, the plurality of User Devices are represented as U₁, U₂ . . . U_{N} (where N represents an integer greater than 2). In the simplified diagram of FIG. 2, two of those User Devices, U₁ and U₂, are shown. Each User Device (U_{1-N}) includes a communication device associated with at least one user. The communication device may include any suitable network-connectable device capable of operating in the manner described herein, such as, but not limited to one or more, desk top computers, laptop computers, mainframe computers, IPAD™ or other electronic pad devices, phones with data processors, personal digital assistants, or the like.

Each User Device (U_{1-N}) includes or operates with a suitable electronic display device (e.g., 210 and 230 in FIG. 2), for displaying information received over the network 10 to the user associated with the User Device. The display device may include one or more of an electronic display screen for displaying video or still image content, a speaker or other audio producing device for displaying (playing) audible content, a tactile output device for displaying (providing) tactile content, combinations thereof, or the like. Each User Device (U_{1-N}) includes one or more input devices (e.g., 220 and 240 in FIG. 2) for inputting textual information, menu selections, and other information such as, but not limited to a keyboard, touch-screen, electronic writing pad or pen, or the like. In particular embodiments, each User Device (U_{1-N}) also includes or operates with a media recording device, such as, but not limited to, a camera, a microphone, a tactile input device, combinations thereof, or the like.

Each User Device (U_{1-N}) includes or operates with suitable media playing software, firmware, hardware, combinations thereof or the like, for playing electronic media content, such as streaming video, streaming audio, streaming tactile signals, other forms of video, audio and/or tactile content, still image content, textual content, combinations thereof, or the like. In particular embodiments, each User Device (U_{1-N}) includes or operates with suitable network browser software (or other suitable communication software, hardware, firmware or combinations thereof) that allows an associated user to access electronic information content over the network 10, such as, but not limited to streaming video, streaming audio, streaming tactile signals, other forms of video, audio and/or tactile content, textual information, combinations thereof, or the like. Such software is stored on one or more electronic storage devices included or associated with each User Device (U_{1-N}) such as, but not limited to, a hard drive, read only memory ROM device, random access memory RAM device, or other non-transient electronic storage device.

A system according to embodiments of the present invention, includes or operates with at least one Data Center device (DC) and, in particular embodiments, two or more Data Center devices represented in FIG. 1 as DC₁, DC₂ . . . DC_{N} (where N represents an integer greater than 2). Each Data Center device (DC_{1-N}) includes a communication device associated with at least one service provider entity that provides one or more services or parts of services described herein. The communication device may include any suitable network-connectable device capable of operating in the manner described herein, such as, but not limited to one or more, desk top computers, laptop computers, mainframe computers, IPAD™ or other electronic pad devices, phones with data processors, personal digital assistants, or the like. Each database includes one or more electronic storage device such as, but not limited to a hard drive, read only memory ROM device, or other device for non-transient storage of electronic data.

In particular embodiments each Data Center device (DC_{1-N}) includes or operates with a chat-room (or on-line meeting) system that includes one or more chat system (CS) servers and software for providing network chat-room connection environments between users on User Devices (U_{1-N}) and performers on Performer Devices (P_{1-N}). Each Data Center device (DC_{1-N}) and/or its associated chat system (CS) includes or operates with one or more databases (e.g., DB in FIG. 2) that store electronic information, such as, but not limited to, user account information as described herein. In the embodiment of FIG. 2, the database DB is shown as being connected to the chat system (CS). In other embodiments, one or more databases DB may be connected to the Data Center (DC) or both the chat system (CS) and the Data Center (DC). While embodiments described herein employ a chat-room system, in other embodiments each Data Center device (DC_{1-N}) includes or operates with other types of systems and software for providing synchronous (or near synchronous) conferencing (including video, audio or audio/video conferencing) through network connections between User Devices (U_{1-N}) and Performer Devices (P_{1-N}) to communicate live input from the Performer Devices (P_{1-N}) to the User Devices (U_{1-N}) and, in certain embodiments, to communicate messages from the User Devices (U_{1-N}) to the Performer Devices (P_{1-N}).

Various chat-room or on-line meeting systems are commonly used for connecting multiple network users in a closed communication session (or meeting) to communicate audio, video and textual information to each other, privately relative to other network users. For example, chat-room systems (also known as chat systems) for video, audio and text communications between specified online users are provided by GOOGLE™, SKYPE™ (MICROSOFT™), TOKBOX™, VEE24™, USTREAM™, IMO.IM™, PALBEE™, and many other companies. Embodiments of the present invention employ similar systems for connecting performers and users. Other embodiments employ other suitable chat-room systems or the like. In particular embodiments, the chat-room system is configured to provide further functions, including tracking of amount of usage by each user and/or by each performer, where the amount of usage may be measured in, for example, the amount of time in a chat-room and/or the number of chat-room visits attended), In further embodiments, the chat-room system is configured to track other data, including, but not limited to, the types of performances selected by each user and/or provided by the performer, the performers or types of performers in the live performances or shows selected by each user, or the like.

In particular embodiments, each Data Center device (DC_{1-N}) includes or operates with one or more webservices that includes a web server and software for providing one or more websites accessible to users on User Devices (U_{1-N}) and/or one or more websites accessible to performers on Performer Devices (P_{1-N}). In particular embodiments, each Data Center device (DC_{1-N}) includes or operates with one or more video servers and software for providing live video streams or other forms of video content. Also in particular embodiments, each Data Center device (DC_{1-N}) includes or operates with a suitable electronic display device for displaying information received over the network 10 to the personnel associated with the service provider entity. The display device may include one or more of an electronic display screen for displaying video or still image content, a speaker or other audio producing device for displaying (playing) audible content, a tactile output device for displaying (providing) tactile content, combinations thereof, or the like.

Each Data Center device (DC_{1-N}) includes or operates with suitable software, hardware, firmware, combinations thereof or the like, for programming or otherwise configuring the Data Center device to operate and provide services described herein. In particular embodiments, such software is stored on one or more electronic storage devices included or associated with the Data Center device (DC_{1-N}) such as, but not limited to, a hard drive, read only memory ROM device, random access memory RAM device, or other non-transient electronic storage device.

According to embodiments of the present invention each Data Center device (DC_{1-N}) provides or is otherwise associated with one or more network sites (such as websites or website pages) accessible by users on User Devices (U_{1-N}). The websites or website pages provide users with access to one or more services that provide displayable content in the form of live performances or shows. The live performances or shows are streamed or otherwise provided to users, as the shows or performances are being carried out by performers and are being inputted through media input devices (e.g., ID_{1-N} in FIG. 2) associated with the Performer Devices (P_{1-N}).

### Access and Registration

A user may access a website or website page for the service through any suitable manner of connection, including, but not limited to, keying in the service's website address through a browser program, selecting an icon for the service on another website page, selecting the service's website from a list of favorites (favorite sites) predefined by or for the user, or the like. In particular embodiments, one or more of the websites or website pages are registration websites or pages that allow each user to employ a registration procedure to register with the service and purchase or otherwise obtain credits or the like, for use in trading for live performance or show content. Accordingly, once connected to the service's website, the user is provided with a registration page. Alternatively, the user may be connected with a menu of selectable live shows or performances or other services and, then, be connected to a registration website or page, in response to the user selecting one of the shows or performances or other services.

In certain embodiments of the present invention, access to the service is provided to users without charge to the users. In other embodiments, users pay for the service by any suitable payment process, including, but not limited to purchasing credits that may be in any suitable form of a value associated with each user's account, including, but not limited to a numerical value, number of tokens, monetary amount, or the like, representing a balance in the user's account. As part of the registration procedure provided by the service entity, a user may purchase or otherwise obtain credits that can be redeemed to obtain selected live performance content. Alternatively or in addition, other credit purchasing/obtaining procedures may be included on websites or pages associated with the service, other than the registration website or page associated with the service. For example, a link may be provided on a menu page that allows a user to link to a website or page to purchase or otherwise obtain and add credits to the user's account. In particular embodiments, the registration websites or pages (and/or other credit purchasing websites or pages associated with the service) are connected with suitable payment services, such as, but not limited to PayPal™, or the like, that assist with collecting money from users for purchasing credits.

The registration procedure provides each registered user with a user identification code (such as, a unique identification code). In this manner, upon registration of a user, the service entity is able associate an identification code, a credit balance and other account information with the user. The service entity maintains a database of information (e.g., in DB in FIG. 2), including user account information (including, but not limited to, one or more user identification codes, credit values and other account information) associated with each registered user.

In particular embodiments, the registration procedure includes one or more authentication procedure to authenticate each registrant as a qualified user. In various embodiments, qualifications to be a qualified user may include, but are not limited to, one or more of an appropriate age (such as an age above a predefined number of years), an appropriate geographic location, an appropriate network address, an appropriate rank or degree holder, an appropriate payment or credit amount, an appropriate subscription plan, or other predefined qualification. In such embodiments, the registration procedure requires the registrant to input or otherwise provide suitable information that identifies or verifies the registrant's age, location, address, rank, degree, payment or other qualification information. Programs and/or personnel associated with the service provider receive the qualification information input by the registrant and determines whether or not the registrant qualifies to be a user. If so, then the user is provided with a user identification code and is allowed to purchase or otherwise obtain credits. Any suitable registration procedures may be employed for registration of users and associating identification codes, credit balances and other account information with registered users, including, but not limited to registration procedures commonly used on a variety of pay-per-view websites and other websites that allow users to purchase or otherwise obtain credits for use of online services.

Once registered, a user can access the service to select and obtain content associated with ongoing live performances or shows. According to embodiments of the present invention, a plurality of users access the service through user devices U_{1-N}, where some users employ an interactive performance mode of the service and other users employ a passive viewing mode of the service. In other embodiments, the interactive performance mode and the passive viewing mode are provided as separate services from the same or different service entities. In the interactive performance mode, the user obtains an interactively directed show, in which the user may provide control information to control aspects of the performance or show or provide demands or recommendations for the performer to perform as part of the performance or show. In particular embodiments, multiple users may actively participate in the same or common interactive performance or show, where each user is able to provide control information to control aspects of the performance or show. On the other hand, in the passive viewing mode, the user may view one or more ongoing interactive performances simultaneously (for example, on a single browser frame), but without the ability to provide control information.

Embodiments of a system and process for providing and obtaining access to services are described with reference to FIG. 2. In FIG. 2, a single Data Center (DC) is shown as providing a complete service to each of the users on User Devices U₁ and U₂, through CDN₁ and CDN₂, respectively. As discussed above, in other embodiments, multiple Data Centers (DC_{1-N}) provide different aspects of the service or different services to the users on User Devices (U_{1-N}). Also, in other embodiments, the Data Center (DC) provides the service directly to the User Devices U₁ and U₂, without employing a CDN (in which case, the CDNs may be omitted from the drawings).

In FIG. 2, multiple Performer Devices (P_{1-N}) are connected to the Data Center DC, for example, through a network connection and a suitable chat server system associated with the Data Center DC. In particular embodiments, each performer associated with the Performer Devices (P_{1-N}) has pre-registered with the service entity and has obtained a performer's account and suitable software applications for chat service and other operations described herein. Each Performer Device (P_{1-N}) includes one or more Input Devices (ID_{1-N}), as described above, for inputting live performance content, as the performers associated with the Performer Devices (P_{1-N}) carry out performances. The Data Center DC controls the communication to User Devices U₁ and U₂ of live content that is being inputted through the Input Devices (ID_{1-N}) of the Performer Device (P_{1-N}), according to services and menu items selected by the users of the User Devices U₁ and U₂. In addition, the Data Center DC manages user account information and performer account information stored in one or more databases DB associated with the Data Center DC.

### Interactive Performance and Passive Viewing Modes/Services

In an example embodiment of FIG. 2, a registered first user, through User Device U₁, accesses the interactive performance mode or service through a network connection with the Data Center DC, by accessing a first website or website page (or a first portion of a first website or page) associated with the interactive performance mode or service. Through that website or website page (or portion of the website or page), the first user is able to select an interactive performance or show for display on a display device 210 associated with the first user's User Device U₁ and input control information through an input device 220 associated with the User Device U₁. In certain embodiments, communication of performances or shows and other communications between the User Device U₁ and the Data Center DC is provided through a Content Delivery Network provider system CDN₁.

In particular embodiments, the first user may input control information before the show starts and/or during the performance of the show. Such control information may be in the form of textual messages, audio input messages, video input messages, or combinations of one or more of such messages to the performer to control or modify the performer's performance in some manner. In further embodiments, the control information may be in the form of instructions to control video, lighting, set configuration, camera angle, height or level of zoom, or other aspects of the performer's performance environment.

The control information may be input through any suitable input device 220 associated with the first user's user device U₁, including, but not limited to a keyboard, microphone, camera, or the like. In particular embodiments, the first user may be provided with a menu of selectable commands associated with a given show or performance (or, in certain embodiments, associated with all of the available shows or performances). In this manner, the first user may control or recommend certain acts for the performer to perform as part of the show.

For example, if the show is a sports show or a game show, the first user may input information to demand or recommend one or more games or plays that the performer is to perform at that time or at some designated time in the performance. As a further example, if the show is an educational show, the first user may input information to demand or recommend that one or more problems be solved, questions be answered, lessons be explained or explained in greater detail, lessons be repeated, or the like. As yet a further example, if the show is an adult entertainment program or burlesque show, the first user may input information to demand or recommend that certain clothing be removed, body parts be revealed, actions be repeated or performed. As yet a further example, if the show is a music program, the first user may input information to demand or recommend that certain instruments, songs, chords, notes, tempo or style be played, or the like. As yet a further example, if the show is a psychic reading, séance or the like, the first user may input information (such as, but not limited to information identifying a subject or person to which the reading or séance is to be directed, or personal information to direct the reading to the user) including demand or recommend to control aspects of the reading or séance. While in the above-described embodiment a first user of user device U₁ accesses the interactive performance mode or service, in other embodiments multiple first users (on separate user devices) are allowed to access the same or a common interactive performance or show, and each of the multiple first users is able to provide control information as discussed above.

According to embodiments of the present invention, a registered second user employing user device U₂ accesses the passive viewing mode or service through a network connection with the Data Center DC (e.g., through CDN₂), by accessing a second website or website page (or a second portion of the first website or page) associated with the passive viewing mode or service. Through that website or website page (or portion of the website or page), the second user is able to select one or more ongoing interactive performance shows for simultaneous display on a display device 230 associated with the second user's User Device U₂, but without the ability to input control information. In certain embodiments, communication of performances or shows and other communications between the User Device U₂ and the Data Center DC is provided through a Content Delivery Network provider system CDN₂.

The second user's User Device U₂ includes or operates with one or more input devices 240, to allow the second user to input information, including menu selections, text, registration information, and other input to access and use the service. In one example embodiment, the second website or website page for the passive viewing mode or service can be accessed through a link provided on the first website or website page for the interactive performance mode or service. Alternatively or in addition, the first website or website page can be accessed through a link provided on the second website or website page.

In an example embodiment, a registered user may access one of the first and second websites or website pages (or first and second portions of a first website or website page) and employ one of the interactive performance mode/service or passive viewing mode/service and, from that website or page, link to the other of the first and second websites or website pages to employ the other mode or service, without re-registering. In particular embodiments, the rate or amount of charges made against the user's available credits differs, depending upon the mode or service employed by the user, as described below.

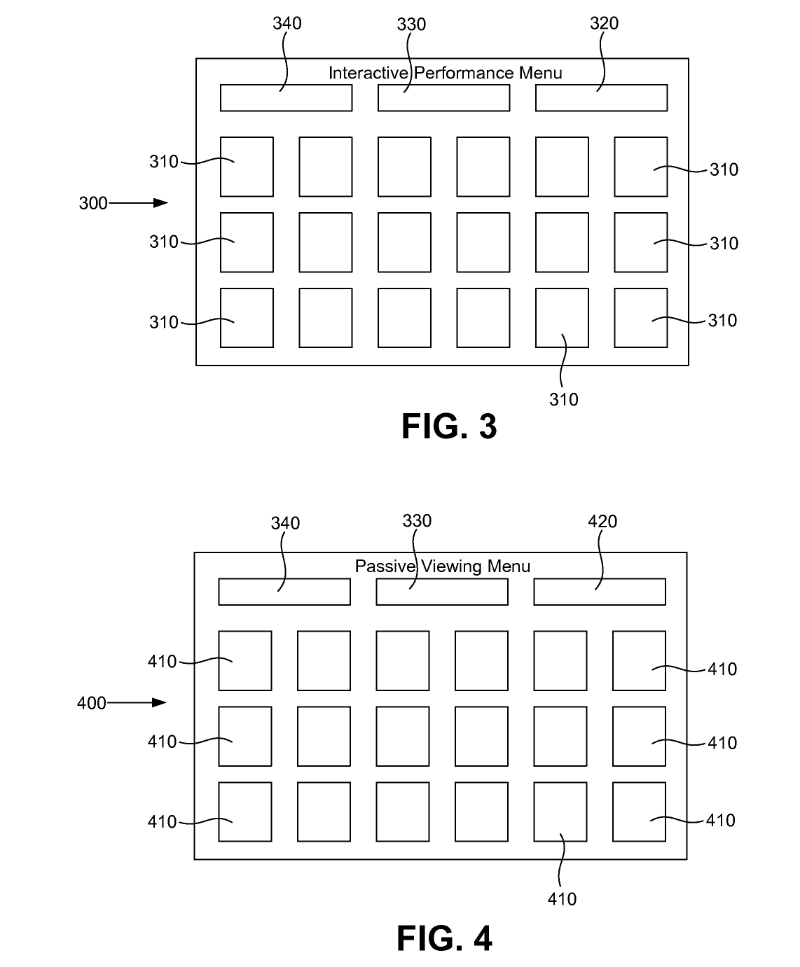

FIG. 3 shows an example embodiment of a display screen of the first website or website page (on the display device 210 associated with the first user's User Device U₁) for employing the interactive performance mode or service. The screen in FIG. 3 includes a menu 300 of selectable performances or shows that are available for selection by the first user. In FIG. 3, the menu 300 is provided in the form of a plurality of selectable menu items in the form of icons 310 that are arranged in a grid pattern of rows and columns on a display device (such as a display screen) associated with the first user's user device U₁. Each different icon 310 is associated with a different show and/or a different performer, with respect to the other icons 310 in the menu. Each icon 310 may include a text description, picture, symbol, pre-recorded video clip, live video, combinations thereof or other information that identifies a particular performance or show.

In certain example embodiments, one or more of the icons 310 includes a photograph, pre-recorded video clip or live video of the performer that conducts the performance associated with the icon. In further embodiments, each icon 310 includes descriptive text that describes some aspect of the performance associated with the icon, such as, but not limited to, the name of the performer, the acts that the performer conducts as part of the show and/or other features that are part of the show. In yet further embodiments, each icon 310 includes an image (photograph or drawing) representing the type of performance associated with that icon. In particular embodiments, each performer using a Performer Device (P1-N) may input information through the Data Center DC for inclusion in the icon 310, where such information may include one or more of a list of acts to be performed in the associated performance or show, a description of the associated performance or show, a photograph, a pre-recorded video clip or a live video. In further particular embodiments, each performer, may access a performer website or page provided by the service entity (through the Data Center DC) to enter or modify information to include on the icon 310 associated with that performer's live performance or show.

In some embodiments, one or more of the icons 310 may include text or other indicia 312, indicating that the show or performer associated with that icon is currently not available, such as, but not limited to, indicia indicating that the show or performer has already been selected by another user and is currently performing an interactive performance or show for that other user. In addition, if a performance or show is currently not available to a first user for an interactive performance due to it having already been selected by another user who is currently obtaining an interactive performance, the indicia 312 on the icon 310 for that performance or show not only indicates that it is currently not available to the first user, but also provides a message indicating that the associated interactive performance or show that is currently being carried out is available to the first user through the passive viewing mode or service.

In the embodiment in FIG. 3, the menu 300 of interactive performances or shows is in the form of a grid of menu items, where each menu item is in the form of an icon 310. However, in other embodiments, the menu of performance or shows may be in the form of a list of menu items, individual menu items that are each displayed one-at-a time for a designated period and then replaced with another menu item such as a slide-show style format, or other suitable format. Also, while menu 300 in the embodiment of FIG. 3 is in the form of a website page, other embodiments may provide a menu in the form of a drop-down menu, a window over another page, or other suitable format.

In the interactive performance mode, the first user may select a menu item by aligning a cursor on one of the icons 310, using a mouse, keyboard keys, joy stick or other suitable input device associated with the first user's User Device U₁. In one example embodiment the first user selects an icon 310 by aligning a cursor onto the desired icon 310 with a mouse and, then, clicking a button or activating another operator on the mouse while the cursor is aligned on the desired icon 310. Other embodiments employ other suitable manners of selecting menu items (such as icons 310), including, but not limited to, arrow keys or other keyboard keys, touch screen selections, or the like.

Once the first user selects a menu item or icon 310, the interactive performance or show associated with that menu item or icon 310 is displayed on the display device associated with the first user's User Device U₁. For example, each icon 310 may include a link to a performer's website page, chat-room, live video, audio or audio/video feed from a web camera, or the like, such that, upon selecting an icon 310, the first user's user device U₁ may be connected to display on its associated display device 210, a website page, chat-room or live video camera image or video associated with that icon. In particular embodiments, the first user is provided with a larger view or a full screen view of the selected interactive performance or show, replacing the multiple smaller menu icons 310.

In addition, upon selecting an icon 310, the first user is able to input information to interact with the performer and control or recommend aspects of the performance. Such information may be text messages, audio voice messages, video, tactile, combinations thereof, or the like. Such information is provided to the performer associated with the selected icon 310, through the Performer Device (P_{1-N}) associated with that performer. Such information may be communicated through any suitable communication format, including, but not limited to, chat-room server software, or the like. In that manner, the first user may select a menu item (such as an icon 310) for an available performer and, in response, receive performance content of a live performance being performed by the performer associated with the selected menu item, for display on the display device associated with the first user's User Device U₁. In addition, the first user may input control information to control or recommend aspects of the performance, where such control information is received by the performer before or during the performance and is used by the performer to modify or otherwise carry on the performance. In this manner, the interactive performance user (the first user) may select an interactive performance or show from the menu 300, interact with the performer of the selected performance or show, and control or direct aspects of the interactive performance or show in a manner determined by that user. Once the user has selected an interactive performance or show, the first user (through User Device U₁) and the performer (through a Performer Device P_{1-N}) associated with the selected performance or show are connected for text and/or audio communication with each other during the interactive performance or show. In particular embodiments, a text field or window that displays user inputted text messages and/or performer inputted text messages, is displayed adjacent to a live video image of the selected interactive performance or show, on the display device 210 associated with the first user's User Device U₁. In other embodiments, the text field or window is initially hidden from view of the first user, but is displayed to the first user upon the first user entering an input command and/or selecting an icon to open the text field or window (e.g., adjacent or over the live video display of the interactive performance or show) on the display device associated with the first user's User Device U₁.

Once the first user has selected a given icon 310 from the menu 300 for an interactive performance, then, for all other users that view the menu 300, the selected icon 310 is either removed from the menu 300, or is modified with indicia that indicates that the performance or show associated with that icon 310 is closed or in use, and the icon is disabled so that the other users are not able to select that icon 310 for an interactive performance or show, while the interactive performance or show for the first user is being carried out.

The menu 300 or the website page associated with the menu 300 includes display areas or fields 320, 330 and 340 for displaying to the user, predefined information and/or links to further pages or websites or other portions of the same website or page. One of the display areas 320 includes a link to a passive viewing feature and mode, described below, and indicia, such as, but not limited to text referring to such a feature and mode. Other information and/or links are included in the other display areas. For example, one of the fields (such as field 330) displays a value associated with the user's account, such as, but not limited to, a value associated with a number of credits or an amount of money remaining or available for use in obtaining live performance content or other services, or other information about the current state of an account associated with the user. Another field (such as field 340) displays a value associated with a current rate of usage of credits or money associated with the user's account, such as, a number of credits (or amount of money or other value) being used per a defined period of time (for example, but not limited to, a number of credits per minute that are currently being used by the user for usage of the service). While the embodiment in FIG. 3 includes three display areas or fields 320, 330 and 340, other embodiments include more or less than three.

The display area or field 320 includes a user-selectable icon for a passive viewing feature that allows a user to view one or more on-going interactive performances, as a passive viewer (without the ability to input control information for such one or more on-going performances). The passive viewing icon 320 may be selected by a user, for example, by aligning a cursor onto the icon 320 with a mouse and clicking or otherwise activating an operator on the mouse. Other embodiments employ other suitable manners of selecting the passive viewing icon 320, including, but not limited to, arrow keys or other keyboard keys, touch screen selections, or the like.

In the example of FIG. 2, the second user, using User Device U₂ connects to the system to access the passive viewing mode or service. For example, upon selecting the passive viewing icon 320 (FIG. 3), the second user's User Device U₂ is linked to the second website or website page or to a second portion of the first website or website page, to provide the second user with information and ability to use the passive viewing mode or service. FIG. 4 shows an example embodiment of a screen of the second website or website page or second portion of the first website or website page (on the display device 230 associated with the second user's User Device U₂). The example screen for employing the passive viewing mode or service shown in FIG. 4 includes a menu 400 of a plurality of selectable menu items 410 representing performances or shows that are available for selection by the second user, through the second user's user device U₂.

The menu 400 in FIG. 4 may be similar to the menu 300 of FIG. 3, but the menu 400 in FIG. 4 includes only menu items 410 for currently ongoing, live performances or shows. In particular embodiments, the menu in FIG. 4 includes only menu items 410 for ongoing performances or shows that other users (such as the first user, through user device U₁) have already selected for the interactive performance mode or service and that are currently being performed as interactive performances for those other users.

In further embodiments, the menu 400 in FIG. 4 includes one or more menu items 410 for one or more ongoing performances or shows, each started on the performer's own initiative (i.e., without having been selected for an interactive performance by a first user). In either case, each menu items 410 in the menu 400 corresponds to a currently ongoing live performance or show. In contrast, the interactive performance menu 300 in FIG. 3 on the first website or website page (or portion of the first website or website page that shows the menu 300) includes selectable performances or shows that are not currently being performed, but that may be selected by a user for a live, interactive performance.

The menu in FIG. 4 is provided in the form of a plurality of selectable menu items in the form of icons 410 that are arranged in a grid pattern of rows and columns on a display device (such as a display screen) associated with the second user's user device U₁. Each different icon 410 is associated with a different ongoing show and/or a different performer in an ongoing show, with respect to the other icons 410 in the menu. Each icon 410 may be a text description, picture, symbol, pre-recorded video clip, live video, combinations thereof, or other information that identifies a particular ongoing performance or show.

The menu 400 or the website page associated with the menu 400 includes display areas or fields 420, 330 and 340 for displaying to the user, predefined information and/or links to further pages or websites. The display area 420 includes a link for the interactive performance feature or mode, described above, and indicia, such as, but not limited to text referring to such a feature or mode. The interactive performance icon 420 may be selected by a user, for example, by aligning a cursor onto the icon 420 with a mouse and activating an operator on the mouse. Other embodiments employ other suitable manners of selecting the passive viewing icon 420, including, but not limited to, arrow keys or other keyboard keys, touch screen selections, or the like. If the second user selects the interactive performance icon 420, the user's User Device U₂ is linked to and provided the interactive performance mode or service website or page menu 300, as shown in FIG. 3.

The other display areas or fields 330 and 340 on the screen shown in FIG. 4 are for displaying account information and rate of usage of credits, or the like, similar to the display areas or fields with corresponding reference numbers in FIG. 3. While the embodiment in FIG. 4 includes three display areas or fields 420, 330 and 340, other embodiments include more or less than three.

Once the second user, through the second user's user device U₂, selects a particular menu item 410 from the menu 400, the second user is provided with video content (as a stream or other form of a video signal), for showing a live performance or show associated with the selected menu item 410. The live performance or show associated with the selected menu item 410 is displayed on the display device 230 associated with the second user's User Device U₂.

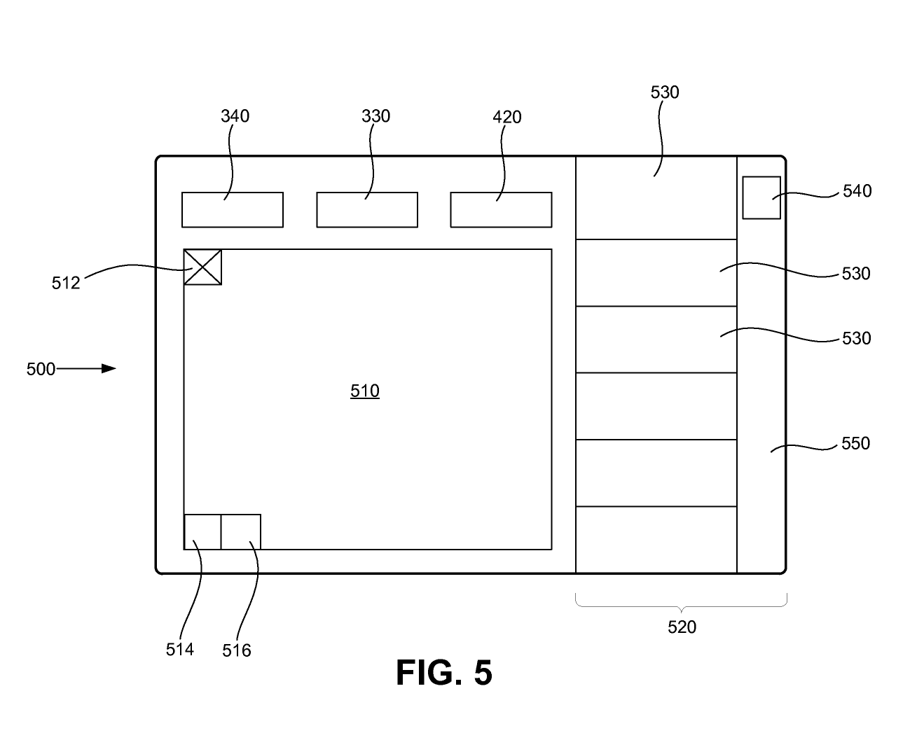

For example, upon the second user selecting a particular menu item 410 from the menu 400, the display device 230 associated with the second user's User Device U₂ displays a new screen 500 shown in the screen diagram of FIG. 5. The screen 500 includes a first area 510 for displaying a video of the live performance or show associated with the selected menu item 410. In particular embodiments, the first area 510 includes most of the overall area of the screen 500, such as, but not limited to, an area encompassing 60% to 90% of the overall area of the screen 500 and, in more particular embodiments, an area encompassing about 80% of the overall area of the screen 500.

In addition, the display screen 500 includes a second area 520 that includes a plurality of menu items 530. Each of the menu items 530 corresponds to a menu item 410 (from the menu 400) that was not selected by the second user. In particular embodiments, the menu items 530 include the same icons that are used for the corresponding menu items 410 of the menu screen 400.

Therefore, when the second user selects a particular menu item 410 from the menu 400 on the screen shown in FIG. 4, the display device associated with the second user's User Device U₂ displays a screen as shown in FIG. 5, including a video showing a live performance or show in display area 510 (corresponding to the selected menu item 410 from the menu 400), as well as a plurality of menu of items 530 in display area 520 (corresponding to the un-selected menu items 410 from the menu 400). The video of the live performance or show in the display area 510 of the screen 500 is displayed in a higher viewing quality than the format of the information provided on the selectable icons 410 of the menu screen 400 (such as, but not limited to one or more of a higher resolution, larger image format, clearer or less obstructed format, live video format, or the like).

In particular embodiments, the menu items 530 in the menu display area 520 of the screen 500 are selectable by the second user. Thus, for example, while a video of a live performance is being shown in the display area 510 of the screen 500, the second user may select one or more additional menu items from the menu display area 520. Upon the second user selecting one additional menu item from the menu display area 520, a video of an ongoing live performance or show associated with the additional menu item is displayed in the display area 510. In particular embodiments, the live performance or show associated with the additional menu item is shown at the same time that the video of the live performance of the initially selected menu item is being shown, for example, in a split screen format.

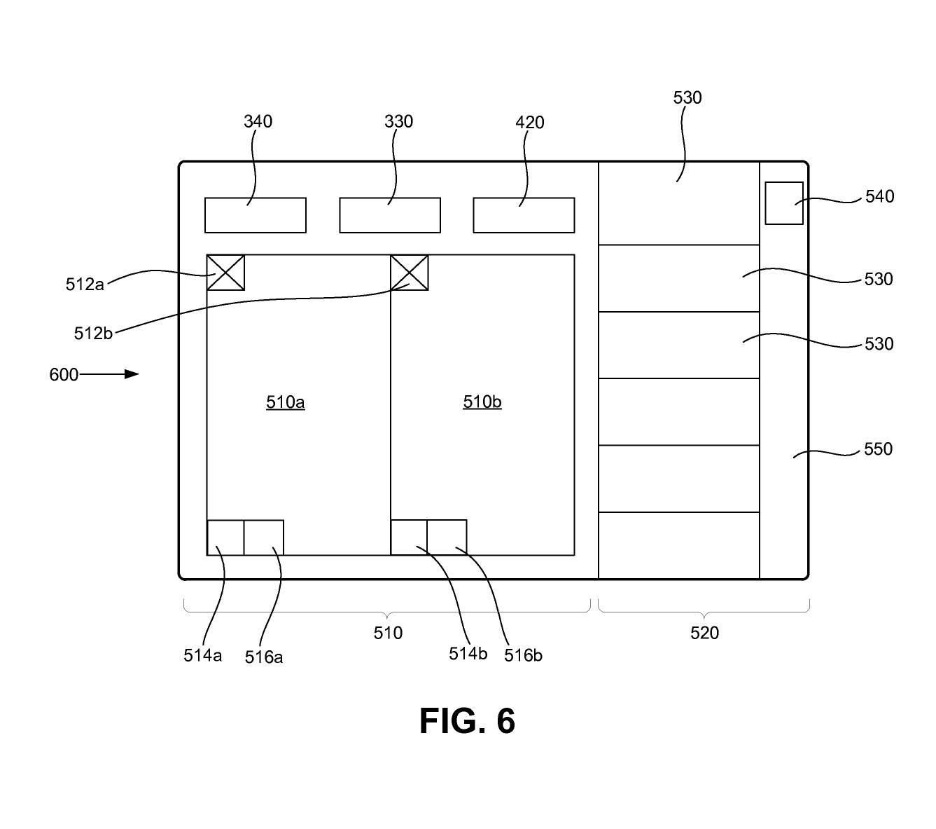

For example, with reference to FIG. 6, when the second user selects one additional menu item, a screen 600 is provided on the display device 230 associated with the second user's user device U₂. The screen 600 is similar to the screen 500, but displays a video of the live performance or show associated with the additional menu item in display area 510b and, simultaneously, displays the video of the live performance of the initially selected menu item in display area 510a.

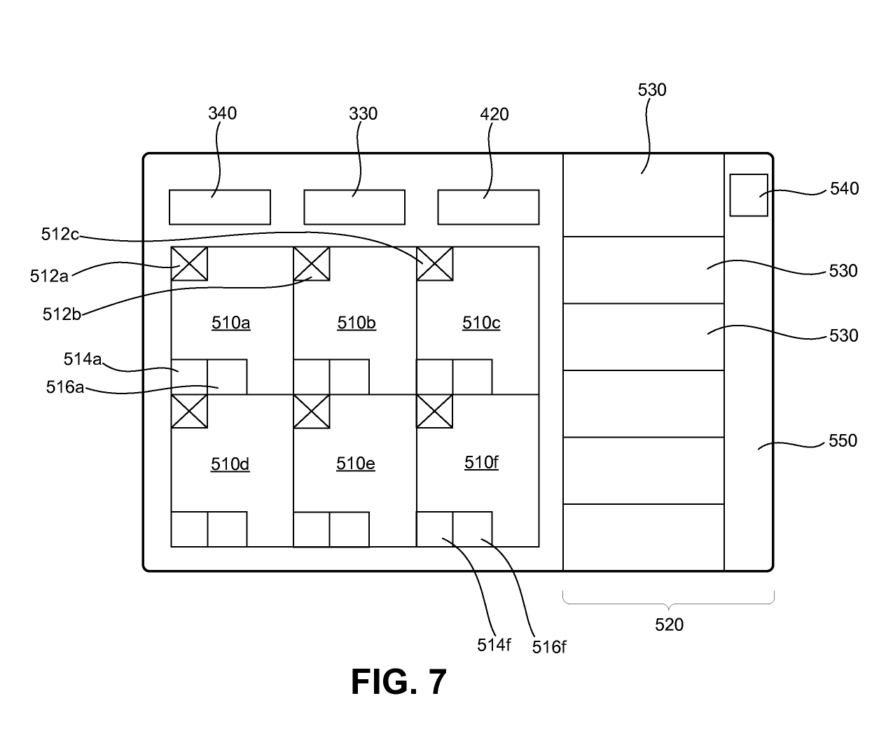

In further embodiments, more additional live performances or shows may be selected from the menu area 520 and, then, displayed simultaneously with previously selected live performances or shows, in display area 510, for example, in a further split screen format. In one example embodiment, any number from one to six live performances or shows may be selected and viewed simultaneously in display area 510. Thus, in the example of FIG. 7, a display screen 700 is similar to the display screen 500, but displays six live performance or show videos 510a-f, simultaneously, in the display area 510. In further embodiments, more than six live performances or shows may be selected and viewed simultaneously. While the embodiments described above display multiple live performance or show videos in the display area 510 in a split screen format, other embodiments are configured to display multiple live performance or show videos, simultaneously, in other formats, including, but not limited to, a slide show format where each of the selected live performance or shows is displayed for a predefined period of time and then replaced with another selected live performance or show, or in an overlay format in which each selected live performance or show video except a top one is displayed over a portion of one or more other performance or show videos.

In this manner, in the passive viewing mode or service, the second user may view multiple ongoing live performances or shows, simultaneously, (for example, through a single browser frame) and may select the additional performances or shows to view from the menu area 520. However, the second user is not provided with the ability to submit control information (e.g., demands or recommendations to the performer) and, instead, is able to passively view the ongoing live performances or shows. On the other hand, each first user who had selected an interactive performance of a live performance or show through the interactive performance mode or service, are able to provide control information (e.g., demands or recommendations to the performer) to control the selected live performance or show.

In particular embodiments, at the end of an interactive live performance or show that is being displayed in the display area 510 of a passive viewing user's user device (for example, upon the performance or show ending at the performer's initiative, at the interactive performance user's initiative, or at a pre-scheduled ending time), the display of that performance or show ends and closes and is removed from the display area 510 of the passive viewer user's user device. In further particular embodiments, each performance or show displayed in the display area 510 includes an associated icon 512 (in FIG. 5) or 512a-f (in FIGS. 6 and 7), that can be selected by the user to close the display of the performance or show video. A close icon 512 (or 512a-f) can be selected, for example, by aligning a cursor onto the close icon with a mouse and activating an operator on the mouse. In other embodiments, other suitable manners of selecting the close icon 512 (or 512a-f) are employed, including, but not limited to keyboard key activations, touch-screen, or the like.

Once a close icon 512 (or 512a-f) has been selected, the performance or show in the associated display area 510 (or 510a-f) is closed and removed from the display area 510 (or 510a-f), and menu item icon for that performance or show is added to the menu items 530 in the display area 520. Thus, the second user on User Device U₂ may select a menu item 410 from the menu screen 400 or a menu item 530 from the menu display area 520 of the screen 500 and, in response, receive video content for the ongoing live performance or show that is associated with the selected menu item, where that video content is displayed in the display area 510 of the screen 500. Thereafter, the second user may select the close icon 512 (or 512a-f) for that live performance or show to close the display of that live performance or show and return a menu item 530 for that performance or show to the menu display area 520 of the screen 500. In a further example embodiment, when the second user selects the close icon 512 while a single live performance or show is being displayed in the display area 510 of the display screen 500 (FIG. 5), the display screen 500 (FIG. 4) is provided to and displayed on the display device 230 associated with the second user's User Device U₂.

In further particular embodiments, each performance or show displayed in the display area 510 includes an associated icon 514 (in FIG. 5) or 514a-f (in FIGS. 6 and 7), that can be selected by the user to keep the video of the ongoing live performance or show playing, but to move the display of the performance or show video to the menu display area 520, as a menu item 530. In such embodiments, upon selecting the icon 514 for a particular display of an ongoing performance or show, the display of the performance or show is reduced to the size of one of the menu item icons 530 and is placed in the menu display area 520, with other menu item icons 530. In this manner, a user may keep viewing a selected ongoing performance or show in the menu display area 520, while freeing space in the display area 510 to open and display one or more other ongoing performances or shows.

In yet further embodiments, one or more icons 516 (in FIG. 5) or 516a-f (in FIGS. 6 and 7) may be provided in or associated with each display of an ongoing live performance or show are provided for selecting other operations. In one example, one or more additional icons 516 (or 516a-f) is provided for one or more of the following operations: submitting a tip of additional credits or other value to the performer performing the live performance or show, obtaining biographic or other information associated with the performer performing the live performance or show, submitting a reservation for an interactive performance or show to the associated performer, adding the associated performer or performance to the user's directory of favorites, or the like. In such embodiments, the user is provided with a website page, link, window, menu or other display (on the display device associated with the user's user device) that provides information and input fields that allow the user to input information, such as, but not limited to, tips, requests for information, reservation information, or the like.

In further particular embodiments, the menu items 530 in the menu display area 520 are arranged in a predefined order. In one example embodiment, the menu item 530 associated with the last performance or show display that had been closed (via close icon 512 or 512a-f) is provided at the top of the menu display area 520. Accordingly, a user who had started to view a display of a selected live performance or show and, then, closed the display of that live performance or show before the performance or show ended, may readily find the menu item icon for that live presentation or show (e.g., to select and reopen the display of that live performance or show) by viewing the upper portion of the menu area 520. In other embodiments, after closing the display of a selected, ongoing live performance or show, the menu item icon for that live performance or show is added to the bottom of the menu display area 520 (instead of the top of the menu display area 520), or is displayed in a separate menu display area (not shown) designated for previously selected menu items.

In yet further embodiments, the menu items 530 in the menu display area 520 are arranged in other suitable manners, such as, but not limited to, an arrangement in which the upper portion of the menu display area 520 shows menu item icons 530 for the most popular performers (performers that have been selected more often than others in the past by other users), the most popular performances or shows (performances or shows that have been selected more often than others in the past by other users), or most or least expensive performances or shows. In such embodiments, the menu item icon for the most popular, most expensive, or least expensive performer, performance or show is arranged at the top of the menu display area 520, followed by the next most popular, expensive or least expensive performer, performance or show, and so on, down the column of menu items 530 in the menu display area 520. In other embodiments, other suitable arrangements of menu items 530 in the menu display area 520 are used.

In particular embodiments, the user is able to arrange the menu item icons 530 in the menu display area 520, according to the preferences of that user. For example, a user may drag and drop menu item icons 530 from one location in the menu display area 520 to another location in the menu display area. In this manner, the user may arrange certain menu item icons 530 at or near the top of the menu display area 520 to, for example, place the more desired menu item icons 530 at a readily accessible location in the menu display area 520.

In the embodiments in FIGS. 5-7, the menu area 520 of the screen 500 includes a scroll bar 540 in a scroll column 550, that allows the second user to scroll through menu items 530 in the display area 520. In particular embodiments, the scroll bar 540 is displayed on the screen 500, only if the number and/or size of the menu items 530 exceeds the number or size that can be displayed simultaneously on the screen 500, when displayed on the display device 230. The scroll bar 540 can be operated, for example, by using a mouse or other input device to align a cursor over the menu bar 540 and dragging the menu bar up or down along the scroll column 550. Alternatively or in addition, scrolling can be accomplished by aligning the cursor over the scroll column 550 or over any portion of the menu area 520, while rotating a scrolling wheel on the mouse. In further embodiments, other suitable procedures for controlling the scrolling of menu items in the menu area 520 are employed.

By scrolling the menu items 530, menu items 530 on one end of the column in the menu area 520 are removed and replaced with further menu items 530 added to the other end of the column in the menu area 520, in a scrolling fashion. In this manner, the second user may scroll through all available multiple menu items 530, while, at any given time, the display area 520 displays a subset (less then all) of the multiple available menu items 530.

The screens 500, 600 and 700 in FIGS. 5-7, each include display areas or fields 420, 330 and 340, for a link to the interactive performance mode or service, and displaying account information and rate of usage of credits, or the like, similar to the display areas or fields with corresponding reference numbers in FIG. 4. While the embodiments in FIGS. 5-7 include three display areas or fields 420, 330 and 340, other embodiments include more or less than three.

In particular embodiments, the user who has selected an interactive performance mode or service (for example, through the menu 300 in FIG. 3) is charged by the service provider for using the interactive performance mode or service. For example, a user who has registered with the service to open a user account, and has purchased or otherwise obtained sufficient credits that are associated with the user's account (as described above), is able to select and obtain video content for an interactive performance. Charges are made and collected by the service, by debiting or otherwise withdrawing credits from the user's account.

In particular embodiments, charges are based on the amount of time that the user is obtaining video content for an interactive performance or show. For example, a charge of X credits per minute or per second (where X is any suitable number, zero or greater) may be applied against the user's account, during the time period in which the user's user device U_{1-N} receives video content in the interactive performance mode or service. In other embodiments, a flat rate charge for each interactive performance or show is charged (such as, but not limited to a single charge of X credits for each selected performance or show, or for each online session, or for usage of the service up to a predefined period of time). In yet other embodiments, a charge is based on a combination of a flat rate and a time-based rate. In particular embodiments, one or more performances or shows may be free of charge to users (e.g., where X is zero), for example, at the initiative of the performer associated with the performances or shows and/or as a promotion or reward for certain users or all users. In yet other embodiments, other suitable rate structures or charges may be applied to the user's account record, for use of the service.

Also in example embodiments described above, a user may access a passive viewing menu 400 to select one or more menu items 410 for the passive viewing mode or service. In particular embodiments, charges are made against the user's account (or debit amounts recorded in the user's account record) and collected by the service for use of the passive viewing mode or service. In certain embodiments, such charges may be based on the amount of time that the user is obtaining video content for passive viewing, a flat rate, a combination of flat rate and time-based rate or other suitable rate structures or charges (as described above with respect to the interactive performance mode or service). In particular embodiments, the flat rate and/or the time-based rate for a user using the passive viewing mode or service is less than the rate for a user using the interactive performance mode or service. In other embodiments, the rates are the same for the passive viewing mode or service and for the interactive performance mode or service. In yet other embodiments, the rates are greater for the passive viewing mode or service than for the interactive performance mode or service.

In further embodiments, the flat rate and/or time-based rate for a user using the passive viewing mode or service changes, depending upon the number of live performances or shows that the user is obtaining at any given time. Thus, for example, a user in the passive viewing mode or service who has selected and is receiving video content for a single ongoing live performance or show (such as represented by the screen shown in FIG. 6) is charged at a rate of X1 credits per minute, during the time period in which the video content for the single performance or show is received by the user's user device. However, a user in the passive viewing mode or service who has selected and is simultaneously receiving video content for two ongoing live performances or shows (such as represented by the screen shown in FIG. 7) is charged at a rate of X2 credits per minute, during the time period in which the video content for the two performances or shows is received by the user's user device.

Similarly, a user in the passive viewing mode or service who has selected and is simultaneously receiving video content for six ongoing live performances or shows (such as represented by the screen shown in FIG. 8) is charged at a rate of X3 credits per minute, during the time period in which the video content for the six performances or shows is received by the user's user device. In particular embodiments, the rate X1 is less than the rate X2, which is less than the rate X3. However, any suitable rate structure, with the same, different or combinations of different and same rates may be applied, based on the number of ongoing live performances or shows is being received by the user's user device. In one example embodiment, a rate structure as shown in the table, below, is employed:

TABLE 1

| # of Simultaneous | Total | | |
|---|---|---|---|
| Performances | CPM | CPM/Perf. | Credits/6 sec. |
| 1 | 20 | 20 | 2 |
| 2 | 20 | 10 | 2 |
| 3 | 30 | 10 | 3 |
| 4 | 40 | 10 | 4 |
| 5 | 50 | 10 | 5 |
| 6 | 60 | 10 | 6 |

The rate structure example represented by Table 1 relates to a user on the User Device U₂ who has selected from 1-6 ongoing, live performances or shows for viewing in the passive viewing mode or service. The first row of Table 1 relates to the situation in which the user on the User Device U₂ has selected one ongoing live performance or show and views the selected show, for example, in the display area 510 on the display screen 500 of FIG. 5. In that situation, the user is charged at a rate of 20 credits per minute (as shown in the second column of Table 1). As only one performance or show is displayed, the charge rate corresponds to 20 credits per minute, per performance or show (as shown in the third column of Table 1). The fourth column in Table 1 shows the charge rate per every 6 second interval.

The second row of Table 1 relates to a situation in which the user on the User Device U₂ has selected two ongoing live performances or shows and views the selected performances or shows simultaneously, for example, in the display area 510a and 510b, on the display screen 500 of FIG. 6. In that situation, the user may be charged at a higher rate than the rate charged for viewing a single show. Alternatively, as shown in Table 1, the user may be charged the same rate as the rate charged for viewing a single show (e.g., to provide the user with additional value of the same charge rate for viewing one or two shows). Thus, in Table 1, the second user is charged at a rate of 20 credits per minute, whether viewing one or two performances or shows (as shown in the second column of Table 1). Table 1 also shows that the charges applied to the second user is 10 credits per minute, per performance or show, when viewing two live performances or shows (as shown in the third column of Table 1).

The third row of Table 1 relates to a situation in which the user on the User Device U₂ has selected three ongoing live performances or shows and views the selected performances or shows simultaneously, for example, in the display area 510 on the display screen 500. In that situation, the user is charged at a higher rate than the rate charged for viewing a one or two performances or shows, such as 30 credits per minute.

Similarly, the fourth, fifth and sixth rows of Table 1 relate to situations in which the user on the User Device U₂ has selected four, five or six ongoing live performances or shows, respectively, and views the selected performances or shows simultaneously in the display area 510. The specific rates shown in Table 1 show an example of a rate structure. Other embodiments employ other suitable rate structures (e.g., different rate amounts and/or intervals different than 6 seconds), where a different rate is applied for each different number of performances or shows selected by the user for simultaneous display and/or where the same rate is applied to some or all different numbers of performances or shows selected by the user.

Accordingly, in the passive viewing mode or service, credits are deducted from the user account, based on the number of live performances or shows that the user has selected for simultaneous viewing and the length of time that such performances or shows are provided to the user's user device, based on a predefined rate structure. Once the user has closed a display of a live presentation or show (e.g., using the close icon 512 or where the presentation or show closes due to the performer's or interactive performance user's initiative), no further charges are applied to the user's account for that live presentation or show after closure of the display.

In particular embodiments, users are charged at a rate (such as X credits per minute), but the service entity collects charges (e.g., deducts credits from the users' accounts) at a predefined interval (such as every Y seconds), where X and Y represent integers greater than zero. For example, in Table 1, the fourth column relates to the number of credits collected for each six-second interval of time, based on a charging rate per minute shown in the second column of that table. A six-second collection interval can be easily calculated from a per-minute rate. However, other embodiments may employ other suitable collection intervals.

In further particular embodiments, the first user on User Device U₁ is charged a fee for using the interactive performance mode or service, as described above, but receives a fee reduction (and/or credits added to that user's account) if and when a second user on User Device U2 selects that interactive performance for viewing through the passive viewing mode or service. In yet further embodiments, the fee charged to the first user is reduced by a greater amount for each additional second user who selects that interactive performance for viewing through the passive viewing mode or service. Accordingly, if a first user selects and directs an interactive performance or show in a manner that interests other users, the first user may help to entice such other users to select and view the ongoing interactive performance or show through the passive viewing mode or service and, thereby, obtain a reduction in charges being applied to the first user's account for the interactive performance or show. In yet other embodiments, if enough second users select the ongoing interactive performance or show being directed by the first user, the charges to the first user can be reduced to zero and, in yet further embodiments, credits or value is added to the first user's account.

Also in particular embodiments, performers receive credits or monetary payment or other forms of compensation for providing performances or shows. For example, in particular embodiments, the Data Center DC (FIG. 2) is configured to maintain an account for each performer in a database (e.g., DB in FIG. 2). The service entity and the performers have predefined compensation arrangements, wherein the service entity adds credits or other form of compensation to the performer's account, each time the performer provides a live performance or show to a user, or at a rate based on the time period in which the performer provides the live performance or show (for example, at a rate of Y per minute, where Y represents any suitable number of credits, monetary value or other form of compensation). In particular embodiments, the performer's compensation or compensation rate is a first value Y1 for providing an interactive performance (to a user who selected the interactive performance mode or service) and is a second value Y2 for each additional user who selects to view that interactive performance in the passive viewing mode or service.

### Live Show Auctions

While embodiments described above may employ predefined rates for usage of the interactive performance mode or service and for the passive viewing mode or service, other embodiments may employ different forms of rate structures. In one example embodiment, users are able to submit bids for an interactive performance or for a passive viewing experience. In such embodiments, the user selects a desired menu item and inputs bid information (through the user's user device U_{1-N}), where the bid information defines the user's bid for the performance or show associated with that menu item. In particular embodiments, the bid information may include a number of credits or an amount of money that the user is willing to pay for the live performance or show.

The service system is configured to receive the user's bid information and a determination is made as to whether or not the bid is acceptable. The determination may include a procedure for comparing the bid information to the user's account record to determine whether or not the user's account has enough credits or other value to cover the bid. If the user's account record indicates sufficient credits or value are available to cover the bid, then the user is allowed to proceed. If the user's account record indicates that the user's account does not have enough credits or other value to cover the bid, then the system denies the bid (and denies that user's access to the selected live performance or show).

Alternatively, or in addition, the determination may include a comparison of the bid amount to a pre-defined credit amount or value (a reserve amount). If the user's account record indicates sufficient credits or value are available to cover the bid, then the user is allowed to proceed. However, if the user's bid is below the reserve amount, then the system denies the bid (and denies that user's access to the selected live performance or show).

In yet further embodiments, the system receives bids from multiple users and communicates the bids to the performer associated with the selected menu item. In such embodiments, for each bid, the performer determines whether or not the bid is acceptable. If the performer accepts a bid, the performer inputs acceptance information, through the performer's performer device P_{1-N} and the system responds to the acceptance information by providing the live performance or show to the user's user device. If the performer does not accept the bid, then the system denies that user's access to the selected live performance or show.

In further embodiments, the performer provides information, through the performer's Performer Device (P_{1-N}), to the service system, where the information relates to a live performance or show. Such information includes one or more of a description or list of activities that will be performed in the live performance or show, a duration of the live performance or show, a reserve amount for bidding and a duration of time in which bids can be submitted. Such information is displayed to a user, for example, as part of the menu item icons on the menu screen 300, as part of the menu item icons on the menu screen 400, as a separate screen or window (or other display format) that is provided to the user's user device in response to the user selecting a menu icon. In further embodiments, the performer is able to provide information to bidders or potential bidders during a bidding period. Such information may help to entice users to make bids or to increase bid amounts.

In particular embodiments, bids made by users are displayed to other users during the bidding period. In one example embodiment, during a bidding period for a particular live performance or show, the amount of the highest bid currently received by the system for that live performance or show is displayed on or adjacent the menu item 310 or 410 associated with that particular live performance or show. In further embodiments, the highest bid for a particular live show or performance is displayed to a user, once the user selects a menu item 310 or 410 (e.g., aligns a mouse with the menu item 310 or 410 or employs another input device or procedure to select the menu item). In this manner, each user is able to view the highest bid received by the system during an ongoing bidding period for a particular live performance or show. Accordingly, a user who is planning to make a bid for a particular live performance or show is able to check the current state of the bids during the bidding period (including the current high bid), and is able to adjust a new bid, based on that information. In yet further embodiments, bids (or the highest currently received bid) is displayed to the performer associated with the live performance or show being bid upon. Accordingly, the performer can view bid information and can input additional information, messages, images or video content for display to users to encourage additional bidding.

In further embodiments, the service system includes an escrow procedure for bidders. In such embodiments, the service system operates to debit the bid amount from the account of the user who has made the currently highest bid during a bidding period. Upon debiting the bid amount from the bidding user's account, the service system transfers the debited bid amount to a separate account, such as an escrow account or the like. If another bid that is greater than the previously received highest bid, is received from another user (or from the same user who made the previously received highest bid), then the service system returns the bid amount of the previously received highest bid to the account of the user who made that bid, and transfers the new highest bid from the bidding user's account to the separate (e.g., escrow) account. In this manner, the service system operates to maintain the highest bid in the separate (e.g., escrow) account, by transferring the currently highest bid amount from the bidding user's account into the separate (e.g., escrow) account, and to return any previously highest bid amount from the separate (e.g., escrow) account to the account of the user who made that previously highest bid. In addition, the service system updates the display of the currently highest bid amount, as higher bids are received and transferred to the separate (e.g., escrow) account, so that other users are able to view the current state of the bids during the bidding period, and are able to decide whether or not to submit a new higher bid, as discussed above.

### Room Receptionist

In particular embodiments, the service system includes one or more databases that store information relating to users, including, but not limited to, user account information discussed above. Other information that can be stored in the database or databases includes one or more of the user's name, a record of the user's historical usage of the service, the user's viewing history (e.g., which performances or shows the user has selected in the past, which products or services the user has purchased or otherwise obtained in past usages of the service, the amount of credits or money the user has spent on past usages of the service, the amount of credits or money currently available in the user's account, or the like).

In certain embodiments, at least some of the stored user information is provided to the performer associated with a live performance or show that a particular user has selected. For example, a performer can be provided with information indicating whether or not the user is a returning user that has previously selected or obtained other live performances or shows (or obtained other services or products) associated with the performer. In particular embodiments, the performer is able to send information to the user, for example, a message that welcomes a returning user back.

In certain embodiments, the performer is provided with a limited amount of information, but is not provided other information about the user (such as, but not limited to, personal information or identification information about the user). Thus, for example, a performer may be provided with information indicating that a particular user is a return customer, but is not provided with the user's name or other user identification information. Similarly, a performer may be provided with information indicating that a particular user has previously made other purchases of services or products through the service, but is not provided with the amount of purchases or information about what services or products were purchased. In this manner, certain information that the user may consider to be personal or otherwise sensitive, can be withheld from the performer, while other information can be provided to the performer to allow the performer to customize a performance and/or provide customized messages to the user.

In further example embodiments, the service system provides the performer with a set of pre-stored (e.g., “canned”) messages that the performer can select and send to a user. In particular embodiments, the performer is provided with a menu of selectable menu items, where each menu item is associated with a different pre-stored messages. The performer can select a desired message (by aligning a mouse with the menu item associated with the desired message or by using other input mechanisms discussed above, to select the menu item). Accordingly, once a user has selected a live presentation or show, the performer associated with that live presentation or show can select a pre-stored message (such as, but not limited to a greeting) and send that message to the user.

In particular embodiments, the pre-stored messages available for a performer to select and send to users are arranged in categories. In one example, such categories relate to types of users, such as, but not limited to, returning users of the service (users that have used the service in the past), returning users of the performer (users that have purchased or otherwise obtained a live performance or show associated with the same performer), users who have a history of sufficiently high usage or spent sufficiently large amounts of credits or money on the service (users who's purchases have exceeded a predefined threshold value for the number of purchases, amounts of credit or money spent, or the like), users who have a sufficiently high number of credits or money available in the user's account (users who's account total exceeds a predefined threshold number of credits or money value), or the like.

In yet further embodiments, the service system can modify the selected pre-stored message with information about the user from the database or databases associated with the service. Thus, for example, the performer may select a generic, pre-stored message, such as a greeting that states: “hi ______, welcome back.” The service system can obtain the user's name or handle (on-line name) from a database and modify the selected message to insert the user's name (e.g., “hi Bob, welcome back”). The modified message is provided to the user, such that the user views a personalized message selected by the performer, without the performer having access to sensitive information about the user (such as the user's name). In other embodiments, other messages, including other greetings or other types of messages are included in the pre-stored set of messages that are available for the performer to select and send.

In embodiments described above, users are able to purchase or otherwise obtain credits that are associated with the user's account and that may be used by the users to obtain video content in either an interactive performance or a passive viewing mode or service. However, in other embodiments, instead of purchasing or otherwise obtaining credits in advance of obtaining video content, the user is able to select menu items (for either the interactive performance or the passive viewing mode or service) and a record of accumulated debit amounts is made and associated with the user's account as the user receives video content associated with the selected menu items. In such embodiments, the user may connect with a payment service or program (as described above) and pay for the total accumulated debits at a designated time after the user has received the video content.

While particular embodiments of the present disclosure have been shown and described, it will be obvious to those skilled in the art that the present disclosure is not limited to the particular embodiments shown and described and that changes and modifications may be made without departing from the spirit and scope of the appended claims.

What is claimed is:

1. A system that provides to second users over an electronic communication network, electronic displayable media content for at least one ongoing, live performance that is being performed for at least one first user, the system comprising at least one server configured to:
provide the second user with a first menu having a plurality of selectable menu items, each menu item corresponding to an ongoing live media performance;
receive selection information from the second user, the selection information corresponding to a selection by the second user of one of the menu items;
provide the second user with displayable content for displaying the ongoing live media performance to which the selected one of the menu items corresponds;
wherein the plurality of selectable menu items include a plurality of menu items that correspond to a respective plurality of ongoing live media performances as those ongoing live media performances are being communicated over the electronic communication network to a respective plurality of first users.

2. A system as recited in claim 1, wherein the at least one server is configured to provide the second user with content for displaying a display screen on a display device associated with the second user, the display screen including a first display area for displaying the ongoing live media performance to which the selection information corresponds, the display screen also including a second display area for displaying a plurality of the menu items that were not selected.

3. A system as recited in claim 2, wherein the at least one server is configured to:
receive selection information from the second user, the selection information corresponding to a selection by the second user of a plurality of the menu items; and
provide the second user with displayable content for displaying a display screen on a display device associated with the second user, the display screen including a first display area for simultaneously displaying the plurality of ongoing live media performances to which the selected plurality of the menu items corresponds, the display screen also including a second display area for displaying a plurality of the menu items that were not selected.

4. A system as recited in claim 3, wherein the first area of the display screen simultaneously displays the plurality of ongoing live media performances in a split-screen format.

5. A system as recited in claim 3, wherein the first area of the display screen simultaneously displays the plurality of ongoing live media performances in a slide-show format.

6. A system as recited in claim 3, wherein the first area of the display screen simultaneously displays the plurality of ongoing live media performances in an overlay format.

7. A system as recited in claim 1, wherein the at least one server is configured to:
receive selection information from the second user, the selection information corresponding to a selection by the second user of a plurality of the menu items; and
provide the second user with displayable content for displaying the plurality of ongoing live media performances to which the selected plurality of the menu items corresponds.

8. A system as recited in claim 7, wherein the at least one server is configured to charge the second user at a rate that depends on how many ongoing, live performances that the content provides to the second user for simultaneously displaying in the first display area.

9. A system as recited in claim 1, wherein the first display area and the second display area are displayed simultaneously in the display screen.

10. A system as recited in claim 1, wherein each first user is connected to the communication network to provide instructions to control one or more aspects of the live media performance being performed for the first user.

11. A system as recited in claim 1, wherein each first user, but not the second user, is connected to the communication network to provide instructions to control one or more aspects of the live media performance being performed for the first user.

12. A system for providing second users with displayable media content for a plurality of ongoing, live media performances being performed for display on electronic media devices associated with a corresponding plurality of first users, the system comprising at least one server configured to:
provide the second user with a menu having a plurality of selectable menu items, each menu item corresponding to a respective one of the ongoing, live media performances;
receive selection information from the second user, the selection information corresponding to a selection of at least one of the ongoing live media performances;
providing the second user with displayable content for displaying each ongoing live media performance to which the selection information corresponds.

13. A system as recited in claim 12, wherein the at least one server is configured to receive selection information from the second user, where the selection information corresponds to a selection of a plurality of the ongoing live media performances;
providing the second user with displayable content for simultaneously displaying the plurality of ongoing live media performances to which the selection information corresponds.

14. A method for providing to second users over an electronic communication network, electronic displayable media content for at least one ongoing, live performance that is being performed for at least one first user, the method comprising:
providing the second user with a first menu having a plurality of selectable menu items, each menu item corresponding to an ongoing live media performance;
receiving selection information from the second user, the selection information corresponding to a selection by the second user of one of the menu items;
providing the second user with displayable content for displaying the ongoing live media performance to which the selected one of the menu items corresponds;
wherein the plurality of selectable menu items include a plurality of menu items that correspond to a respective plurality of ongoing live media performances as those ongoing live media performances are being communicated over the electronic communication network to a respective plurality of first users.

15. A method as recited in claim 14, wherein providing the second user with displayable content comprises providing the second user with content for displaying a display screen on a display device associated with the second user, the display screen including a first display area for displaying the ongoing live media performance to which the selection information corresponds, the display screen also including a second display area for displaying a plurality of the menu items that were not selected.

16. A method as recited in claim 15, wherein receiving selection information from the second user, comprises receiving selection information corresponding to a selection by the second user of a plurality of the menu items; and
wherein providing the second user with displayable content comprises providing the second user with displayable content for displaying a display screen on a display device associated with the second user, the display screen including a first display area for simultaneously displaying the plurality of ongoing live media performances to which the selected plurality of the menu items corresponds, the display screen also including a second display area for displaying a plurality of the menu items that were not selected.

17. A method as recited in claim 16, further comprising simultaneously displaying the plurality of ongoing live media performances in a split-screen format in the first display area.

18. A method as recited in claim 14, wherein receiving selection information from the second user comprises receiving selection information corresponding to a selection by the second user of a plurality of the menu items; and wherein providing the second user with displayable content comprises providing the second user with displayable content for simultaneously displaying the plurality of ongoing live media performances to which the selected plurality of the menu items correspond.

19. A method as recited in claim 18, further comprising charging the second user at a rate that depends on how many ongoing, live performances that the content provides to the second user for simultaneously displaying in the first display area.

20. A method as recited in claim 14, wherein the first display area and the second display area are displayed simultaneously in the display screen.
